(19) United States
(12) Patent Application Publication
(10) Pub. No.: US 2010/0068360 A1
(43) Pub. Date: Mar. 18, 2010

(54) METHOD OF OPERATING A CONTAINER FILLING PLANT FOR FILLING CONTAINERS WITH FILTERED LIQUID, SUCH AS BEER

(76) Inventors: Hans WESTNER, Hochstatten (DE); Andreas ZELLER, Bad Kreuznach (DE)

Correspondence Address: NILS H. LJUNGMAN & ASSOCIATES, P. O. BOX 130, GREENSBURG, PA, 15601-0130, US

(21) Appl. No.: 12/560,487

(22) Filed: Sep. 16, 2009

Related U.S. Application Data
(63) Continuation-in-part of application No. PCT/EP2008/001034, filed on Feb. 12, 2008.

(30) Foreign Application Priority Data
Mar. 16, 2007 (DE) 10 2007 013 275.3

(51) Int. Cl. B01D 37/00; B67C 3/00; B67C 3/22; C12H 1/16; B01D 37/02

(52) U.S. Cl. 426/397; 426/423; 210/778; 210/797; 210/779

(57) ABSTRACT

A method of operating a container filling plant for filling containers with filtered liquid, such as beer. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

This application is a Continuation-In-Part application of International Patent Application No. PCT/EP2008/001034, filed on Feb. 12, 2008, which claims priority from Federal Republic of Germany Patent Application No. 10 2007 013 275.3, filed on Mar. 16, 2007. International Patent Application No. PCT/EP2008/001034 was pending as of the filing date of this application. The United States was an elected state in International Patent Application No. PCT/EP2008/001034.

### BACKGROUND

1. Technical Field

The present application relates to a regeneration method for the regeneration, without any waste of product, of filter modules that comprise at least one filter element, such as a filter candle, for example, whereby the regeneration method, with reference to a production process of which it is a part, comprises the production steps of final running (final runnings step), filter cleaning (cleaning step) and first running (first runnings step), whereby at the end of the cleaning step the filter module is filled with gas, and the liquid in the filter module is thereby expelled.

2. Background Information

Background information is for informational purposes only and does not necessarily admit that subsequently mentioned information and publications are prior art.

Some filtration methods may be used for beer. Other methods may be for the regeneration, cleaning, starting and stopping of filter units. A conventional filter module used in the production of beer comprises or comprises a plurality of filter candles. These filter candles, when operated in this type of production process, are charged with a filter cake made of a filter medium to achieve the required and/or desired filtering capability. One conventional filter medium is kieselguhr, which can be optimized by the addition of a stabilizer such as a kieselgel, for example. On account of the deposits in and on the filter cake, the pressure on the unfiltered beer side, which is the filter input side, must or should be continuously or substantially continuously increased to maintain a constant or substantially constant volume flow through the filter module.

Because the amount by which the pressure can be increased is technically limited, the filter module must or should be regularly regenerated. For this purpose, any beer that is present in the filter is displaced with degassed water, a process that requires and/or desires approximately 1.2 times the boiler contents. These final runnings are collected up to a specified original wort content, which is generally approximately three percent, in a special tank which is also called the first/final runnings tank. The highly diluted beer is discarded. The boiler which is located upstream of the filter module is then pressurized with compressed air and thus the liquid is expelled through the filter module in the permeate direction. The filter medium and residue thereby remain in the filter candle in the form of the filter cake.

The used filter cake is then blasted out by pulses of water and compressed air that are introduced from the filtered beer side. The suspension that remains on the bottom of the filter module is flushed and pumped out.

Then the filter elements are cleaned by conducting a variety of cleaning agents, generally lye and/or acids, through the filter module. These cleaning gents are then washed out by means of water, in one possible embodiment degassed water. Upon completion of the cleaning step, the filter module is filled with clear water. That is followed by a first running or first running step, in which the filter elements are recharged by means of a flushing with, among other things, a suitable layer of filter medium. During this flushing step, any water that is present is transported through the filter in circulation and the filter medium, which is generally kieselguhr, is introduced until the desired charging of the filter elements with a filter cake is achieved. In the next step, the water which is present in the system is successively expelled by the beer that is introduced. The displaced liquid, which is a mixed phase with increasing original wort content, is discarded up to a specified original wort content, which is generally approximately three percent. Beer with a higher original wort content is also stored in the above mentioned first and final runnings tank and is mixed in with the production. Production via this special filter module continues until the maximum operating pressure is reached, whereby kieselguhr is continuously added in controlled quantities into the circuit in a low concentration upstream of the filter module.

For the first running step, this regeneration method of the prior art requires and/or desires a large volume of beer, which is almost always or substantially always discarded. This method also requires and/or desired large buffer volumes and the corresponding equipment. These requirements or desires are disadvantages from the point of view of environmental protection and economical design and operation.

### OBJECT OR OBJECTS

An object of the present application is therefore to eliminate, restrict, and/or minimize these disadvantages and to create a technically equivalent method which produces less environmental pollution.

### SUMMARY

The present application teaches that this object is accomplished by the method for the regeneration of filter modules without any waste of product, whereby the filter module comprises at least one filter element and the regeneration method, with reference to a the production process of which it is a part, comprises the steps listed below:

a) Production final running (final runnings step),

b) Filter cleaning (cleaning step) and

c) Production first running (first runnings step).

Some characteristics of steps a) to c) are

a) Final running step, the product is centrifuged out of the filter module;

b) Cleaning step, which removes and cleans any deposits, in one possible embodiment filter cake and filter medium, from at least one filter element;

c) First running step, which charges at least one filter element with filter medium and fills the filter module with product.

In the method according to the present application, at the beginning and at the end of the cleaning step, the filter module is filled with gas, whereby any liquid that is in the filter module is driven out. In one possible embodiment of the present application, the filter module is filled with carbon dioxide, nitrogen, compressed air or a mixture of these gases, whereby a pressure of one bar to a maximum eight bar is established. In one possible embodiment of the present application, a pressure of one and one-half bar to two bar is achieved. One improvement comprises emptying the filter module using gas both at the beginning and at the end of the cleaning step. The volume of liquid that cannot be displaced by the introduction of the gas at the beginning of the cleaning step, such as the liquid in the sump of the filter module, for example, can be transported into a separate intermediate tank and can then be introduced into the piping system of the unfiltered beer upstream of the filter module during subsequent production.

The present application therefore teaches a regeneration method which does not require and/or desire any large-volume first and final runnings tank with the corresponding connections, piping, pump, open-loop and closed-loop control systems. As a result of the new method, the first and final runnings tanks can be eliminated, and the waste of unusable mixed phases can be largely prevented, restricted, and/or minimized.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Developments of the present application are described according to the present application. The present application is explained in greater detail below with reference to the figures, in which:

FIG. 1 shows a one possible embodiment of the present application;

FIG. 2 shows a block diagram of an arrangement for use with the method of the present application; and

FIG. 3 shows a block diagram of an arrangement for use with the method of the present application.

### DESCRIPTION OF EMBODIMENT OR EMBODIMENTS

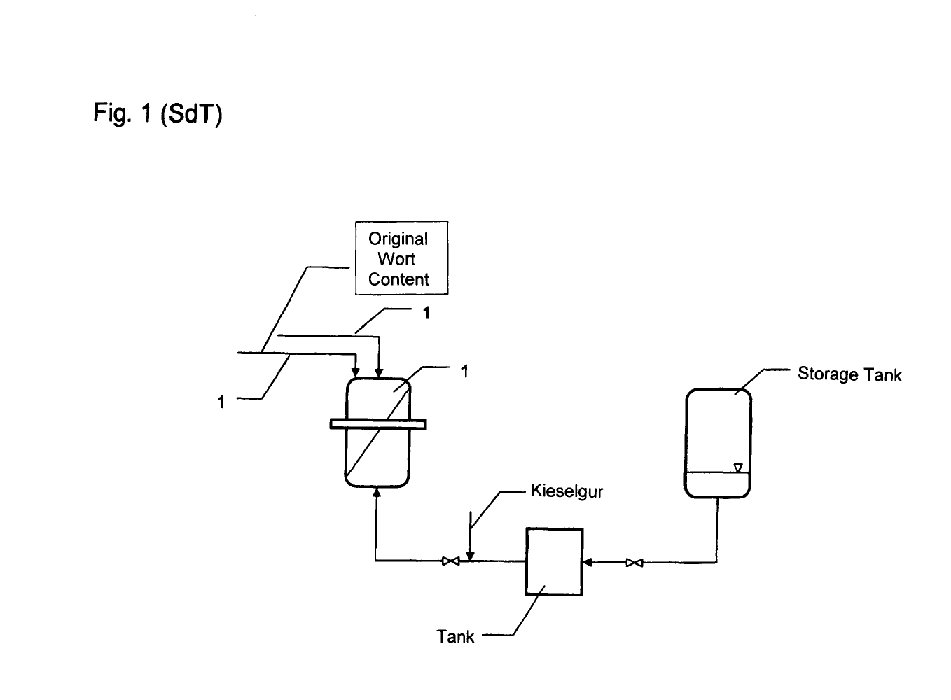

In one embodiment of the method as may be seen in FIG. 1, the gas-filled filter module is then filled with filtered beer, whereby the gas in the system is displaced and then the flushing is initiated. For this purpose the beer that is present in the circuit is transported through the filter module, and a suspension that comprises beer and/or water and filter medium is introduced into the filter module or the piping system of the circulating flow. Alternatively, the filter medium can be added in pure form to the flow of liquid transported in circulation through the filter. The liquid displaced by the introduction of the suspension can be pumped into a separate unfiltered beer buffer tank or into a separate intermediate tank. Once production has resumed, the fluid stored in this manner is then re-introduced upstream of the filter module. In one possible embodiment of the present application, the storage of fluid in a separate intermediate tank allows the unfiltered beer coming from the production to not be contaminated with the mixed phase and any amounts of kieselguhr it may include. With the conventional filter sizes, such an intermediate tank can be very small in comparison to the other storage tanks. When production resumes, the volume of liquid from the intermediate tank is introduced into the feed line of the filter module. The liquid volume, however, can also be introduced by means of a pump into the suspension during a subsequent first runnings step for purposes of flushing out the filter.

In one variant of the method according to the present application, a suspension comprising beer and filter medium is introduced directly into the gas-filled, empty filter module to perform the flushing. In one possible embodiment of the present application, the need and/or desire is eliminated, restricted, and/or minimized for an additional mixed phase and its storage.

The present application also comprises a method for brewing beer, in which at least one filter module is regenerated using a regeneration method as described in one of the method variants cited above.

The method according to the present application is explained above on the basis of one concrete example. Naturally, the process parameters can be varied in a suitable manner by a technician skilled in the art as a function of the individual requirements of the process and plant.

In a test setup, a filter module with 18 filter candles which is designed for a filter output of 2 m³/h was used in a filtering method. By introducing carbon dioxide at a pressure of up to one and one-half bar into the filter, the clear water that was present was displaced. Then the filter module was flooded with filtered beer and flushed with a suspension of beer and kieselguhr, which was transported into the feed line of the filter module. The flushing was performed at a rate of one kilogram per meter squared. When the suspension was introduced, the beer that was present was displaced and transported into a separate intermediate tank. The additional intermediate tank provided for this purpose had a capacity of approximately 0.08 meters cubed. This volume of beer was fed into the subsequent production upstream of the filter module.

In addition to that which was described above, it was also observed that as a result of the simplified regeneration method according to the present application and the reduced volume of liquid that had to be transported, the time required and/or desired for the filter regeneration could be reduced by approximately ten percent.

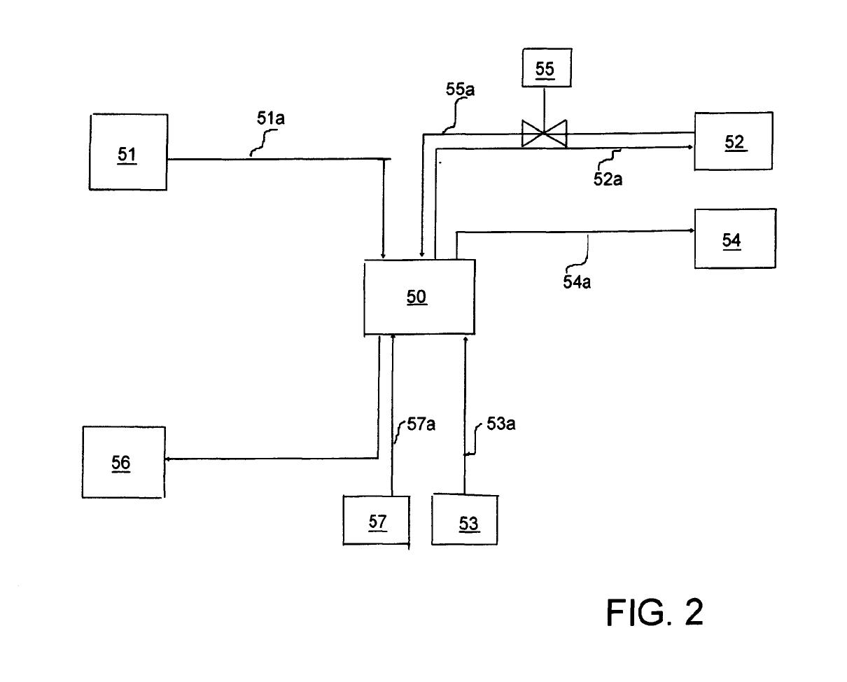

In FIG. 2, a filter 50 may be configured to accept unfiltered beer or unfiltered liquid from a source 51. The source 51 may be a source of unfiltered beer or a source of unfiltered liquid. The unfiltered liquid or beer may be fed to the filter 50 by a line 51a. To begin cleaning of the filter 50, the flow of unfiltered beer or liquid to the filter 50 is stopped. Gas is introduced or blown into the filter from a source of compressed gas 57 and through a line 57a. The remaining unfiltered beer or liquid in the filter 50 is transported through the line 52a and into the storage tank for removed beer or liquid 52. Once the unfiltered liquid or unfiltered beer is removed from filter 50, water is introduced into the filter 50 to remove any filter cake or filtrate or build-up in the filter 50. This build up or filter cake is transported by 54a to a processing arrangement 54, which may be configured to process the filter cake or discard the filter cake.

Once the filter 50 has been cleaned, gas is again blown into or introduced into the filter 50 from the source of compressed gas 57 to remove any water from the filter 50. When the filter 50 is sufficiently cleaned out and dry, the filter 50 is recharged by adding in fresh filter material or fresh diatomaceous earth into the filter 50 from a source of filter material or diatomaceous earth 55. The stored unfiltered liquid or beer is then fed from the storage tank 52 into the filter 50 to be filtered. Once the unfiltered beer or liquid is filtered by the filter 50, the filtered beer or filtered liquid may then be fed to an arrangement 56. The arrangement 56 may temporarily store or hold the filtered beer or liquid before the liquid is bottled.

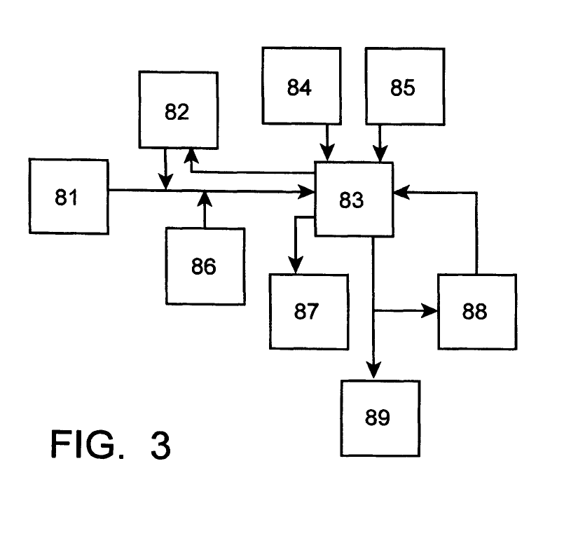

In at least one possible embodiment as shown in FIG. 3, there is a supply of unfiltered beer 81. Unfiltered beer is conducted from the supply 81 to a filter tank 83. The unfiltered beer is filtered in the filter tank 83 using a filter material, such as diatomaceous earth. The beer exits the filter tank 83 as filtered beer, which is then conducted to a filling arrangement 89 for dispensing into bottles or other containers. Eventually, the filter tank 83 experiences a decrease in flow and an increase in pressure due to buildup of filtrate in the filter tank 83. When the pressure reaches an undesired level, a flushing of the filter tank 83 of the filtrate and the filter material is required. In the embodiment shown in FIG. 3, gas from a gas supply 84 is introduced into the filter tank 83. The gas fills a filter tank 83 and drives out the liquid in the filter tank 83. In at least one possible embodiment, some of the liquid is conducted out as filtered beer with at least a portion of the filtered beer being conducted into filtered beer storage tank 88, while some of the liquid is conducted to intermediate storage tank 82. After the liquid has been conducted out of the filter tank 83, water and/or cleaning agents from the cleaning supply 85 are utilized to clean out the filter tank 83. The water and/or cleaning agents are then conducted out of the filter tank 83, along with the filtrate and used filter material, via drainage arrangement 87. Once the cleaning process is complete, gas is again introduced from the gas supply 84 into the filter tank 83 to thereby drive out any remaining cleaning liquid. The filter tank 83 is then filled with filtered beer from the filter beer storage tank 88, which filtered beer thereby drives out the gas from the filter tank 83. Either after or during filling of the filter tank 83 with the filtered beer, a mix of unfiltered beer from the supply of unfiltered beer 81, beer from the intermediate storage tank 82, and filter material, such as diatomaceous earth, from the filter material supply 86, is conducted into the filter tank 83. In at least one possible embodiment, this mixture of beer and filter material is circulated through the filter tank 83 and the intermediate storage tank 82, and optionally the filtered beer storage tank 88, until the filter tank 83 is refilled or recharged with filter material to a level sufficient to achieve desired filtration of the beer.

A method of regeneration for the lossless regeneration of filter modules which comprise at least one filter element, wherein the method of regeneration, with respect to a method of production connected therewith, comprises the steps of production feeding (feeding step), filter cleaning (cleaning step), and production output (output step). In the feeding step, product is fed out of the filter module. In the cleaning step, the at least one filter element is freed of deposits, in one possible embodiment filter cake and filter adjuncts, and cleaned. In the output step, the at least one filter element is supplied with filter adjunct, and the filter module is filled with product. The filter module is filled with gas at the beginning and/or the end of the cleaning step, and the liquid in the filter module is thereby driven out.

One feature or aspect of an embodiment is believed at the time of the filing of this patent application to possibly reside broadly in a regeneration method for the regeneration, with no waste of product, of filter modules, comprising at least one filter element, whereby the regeneration method, with reference to the production process of which it is a part, comprises the steps production final runnings (final runnings step), filter cleaning (cleaning step) and production first runnings (first runnings step), whereby during the final runnings step, product is transported out of the filter module, during the cleaning step the at least one filter element is freed of deposits, in one possible embodiment in the form of filter cake and filter medium, and cleaned, and during the first runnings step the at least one filter element is charged with filter medium and the filter module is filled with product, wherein the filter module, at the end of the cleaning step, is filled with gas, whereby the liquid in the filter module is driven out.

Another feature or aspect of an embodiment is believed at the time of the filing of this patent application to possibly reside broadly in the method, wherein the filter module is filled with gas at the beginning and end of the cleaning step, whereby the liquid in the filter module is driven out.

Yet another feature or aspect of an embodiment is believed at the time of the filing of this patent application to possibly reside broadly in the method, wherein the filter module is filled with carbon dioxide, nitrogen, compressed air or a mixture of these gases.

Still another feature or aspect of an embodiment is believed at the time of the filing of this patent application to possibly reside broadly in the method, wherein the filter module is filled at a pressure of one bar to a maximum eight bar, in one possible embodiment up to a pressure of one and one-half bar to two bar.

A further feature or aspect of an embodiment is believed at the time of the filing of this patent application to possibly reside broadly in the method, wherein the at least one filter module is a filter candle, and the filter module in one possible embodiment comprises a plurality of filter candles.

Another feature or aspect of an embodiment is believed at the time of the filing of this patent application to possibly reside broadly in the method, wherein the gas-filled filter module is filled with filtered beer, and then the at least one filter element is flushed, whereby a suspension of bee and/or water and filter medium is introduced into the filter module and is conducted for a period of time in circulation through the filter module.

Yet another feature or aspect of an embodiment is believed at the time of the filing of this patent application to possibly reside broadly in the method, wherein the liquid displaced by the introduction of the suspension is transported into an unfiltered beer buffer tank.

Still another feature or aspect of an embodiment is believed at the time of the filing of this patent application to possibly reside broadly in the method, wherein the liquid displaced by the introduction of the suspension is transported into a separate intermediate tank and when production resumes is introduced upstream of the filter module into the piping system for the unfiltered beer.

A further feature or aspect of an embodiment is believed at the time of the filing of this patent application to possibly reside broadly in the method, wherein the fluid that cannot be displaced by the introduction of the gas at the beginning of the cleaning step is transported into a separate intermediate tank, and for subsequent production is introduced upstream of the filter module into the piping system for the unfiltered beer.

Another feature or aspect of an embodiment is believed at the time of the filing of this patent application to possibly reside broadly in the method, wherein the at least one filter element is flushed directly into the gas-filled filter module, whereby a suspension of beer and filter medium is displaced into the filter module and is conducted for a period of time in circulation through the filter module, and the gas is at least partly displaced from the filter module.

Yet another feature or aspect of an embodiment is believed at the time of the filing of this patent application to possibly reside broadly in the method, wherein the liquid volume from the intermediate tank is introduced at least partly into the suspension during a subsequent first runnings step during the flushing by means of a pump.

Still another feature or aspect of an embodiment is believed at the time of the filing of this patent application to possibly reside broadly in a method for the brewing of beer, wherein at least one filter module is regenerated by a regeneration method according to the present application.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

Some examples of filters, filter materials, and/or methods of filtering beer, which may possibly be utilized or adapted for use with at least one possible embodiment of the present application, may possibly be found in the following U.S. patents: No. 7,132,119, having the title “Method for producing beer,” published on Nov. 7, 2006; No. 6,773,601, having the title “Method for the removal of particulate matter from aqueous suspension,” published on Aug. 10, 2004; No. 4,844,932, having the title “Separation of wort from mash,” published on Jul. 4, 1989; No. 4,045,342, having the title “Method and apparatus for filtering,” published on Aug. 30, 1977; and No. 4,943,374, having the title “Use of a microporous membrane constructed of polyether sulfon and hydrophilization agent for the filtration of beer,” published on Jul. 24, 1990.

U.S. Pat. No. 7,255,141, having the title “BEVERAGE BOTTLING PLANT FOR FILLING BOTTLES WITH A LIQUID BEVERAGE FILLING MATERIAL, A CONTAINER FILLING PLANT CONTAINER FILLING MACHINE, AND A FILTER APPARATUS FOR FILTERING A LIQUID BEVERAGE,” published on Aug. 14, 2007, and its Patent Application Publication No. 2005/0092184, having the same title, and published on May 5, 2005, are hereby incorporated by reference as if set for in their entirety herein.

All of the patents, patent applications or patent publications, which were cited in the German Office Action dated Jan. 31, 2008, and/or cited elsewhere are hereby incorporated by reference as if set forth in their entirety herein as follows: U.S. Pat. No. 5,085,997, having the title “METHOD OF SEPARATING YEASTS FROM FERMENTATION LIQUORS,” published on Feb. 4, 1992; and GB 12 15 397, having the title “IMPROVEMENTS IN OR RELATING TO THE REMOVAL AND DISPOSAL OF RADIOACTIVE IMPURITIES FROM CONTAMINATED LIQUIDS,” published on Dec. 9, 1970.

All of the patents, patent applications or patent publications, which were cited in the International Search Report dated May 19, 2008, and/or cited elsewhere are hereby incorporated by reference as if set forth in their entirety herein as follows: DE 196 52 499, having the following English translation of the German title “Drinks industry filter regeneration process discharges filter agent to washing,” published on Jun. 18, 1998; EP 0 460 499, having the following English translation of the German title “Method for the filtration of beverages and of chemical, pharmaceutical and similar liquids,” published on Dec. 11, 1991; EP 0 255 696, having the following English translation of the German title “Process and filter material for precoating filtration of beverages,” published on Feb. 10, 1988; WO 86/05511, having the title “PROCESS FOR THE SECONDARY PURIFICATION AND STABILIZATION OF LIQUIDS CONTAINING POLYPHENOLS AND/OR PROTEINS, PARTICULARLY BEVERAGES AND MORE ESPECIALLY BEER,” published on Sep. 25, 1986; and WO 99/16531, having the title “REGENERATION A FILTER MEDIA,” published on Apr. 8, 1999.

The patents, patent applications, and patent publication listed above in the preceding four paragraphs are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2007 013 275.3, filed on Mar. 16, 2007, having inventors Hans WESTNER and Andreas ZELLER, and DE-OS 10 2007 013 275.3 and DE-PS 10 2007 013 275.3, and International Application No. PCT/EP2008/001034, filed on Feb. 12, 2008, having WIPO Publication No. WO 2008/113435 and inventors Hans WESTNER and Andreas ZELLER, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the corresponding foreign equivalent patent application(s), that is, PCT/EP2008/001034 and German Patent Application 10 2007 013 275.3, is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2008/001034 and DE 10 2007 013 275.3 from which this patent application claims priority which do not have to do with the correction of the translation in this patent application are not to be included in this patent application in the incorporation by reference.

Any statements about admissions of prior art in the original foreign patent applications PCT/EP2008/001034 and DE 10 2007 013 275.3 are not to be included in this patent application in the incorporation by reference, since the laws relating to prior art in non-U.S. Patent Offices and courts may be substantially different from the Patent Laws of the United States.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

What is claimed is:

1. A method of operating a container filling plant being configured to fill containers, said container filling plant comprising: a filling machine being configured to fill empty containers with filtered beer; a conveyor arrangement being configured and disposed to move empty containers to said filling machine; and a filtering arrangement being configured to filter beer, said filtering arrangement comprising: a filter; a source of compressed gas being configured and disposed to supply gas to said filter; a storage tank being configured and disposed to store unfiltered beer removed from said filter; a source of water being configured and disposed to supply water to said filter to clean said filter; a source of fresh diatomaceous earth being configured and disposed to supply fresh diatomaceous earth to said filter; said method comprising the steps of:
filtering unfiltered beer in said filtering arrangement;
stopping the flow of beer through said filtering arrangement and stopping filtering of beer upon filtered build-up in said filter exceeding a predetermined level;
blowing gas through said filter and removing remaining beer from said filter to clean said filter;
storing said removed beer in said storage tank;
flowing water, from said source of water, through said filter and removing filtered build-up and diatomaceous earth from said filter;
discarding said removed filtered build-up and said removed diatomaceous earth;
blowing gas through said filter and removing remaining water from said filter;
recharging said filter by flowing unfiltered beer and fresh diatomaceous earth, from said source of fresh diatomaceous earth, through said filter;
flowing said stored removed beer through said filter and filtering said removed beer in said filter;
flowing unfiltered beer from said source of unfiltered beer through said filter and filtering said unfiltered beer with said filter; and
filling empty containers with filtered beer in said filling machine.

2. The method of operating a container filling plant according to claim 1, wherein said steps of blowing gas through said filter further comprise blowing at least one of: carbon dioxide, nitrogen, and compressed air through said filter.

3. The method of operating a container filling plant according to claim 2, wherein said filter is filled at a pressure of one of (A) and (B):
(A) one bar to a maximum 8 bar; and
(B) one and one-half bar to two bar.

4. The method of operating a container filling plant according to claim 3, wherein:
said filter comprises a filter candle; and
said filter arrangement comprises at least one filter candle.

5. The method of operating a container filling plant according to claim 4, wherein:
the gas-filled filter is filled with filtered liquid, and then said at least one filter candle is flushed, whereby a suspension of liquid and/or water and diatomaceous earth is introduced into said filter and is conducted for a period of time in circulation through said filter;
the liquid displaced by the introduction of the suspension is transported into an unfiltered beer buffer tank;
the liquid displaced by the introduction of the suspension is transported into a separate intermediate tank and when production resumes is introduced upstream of said filter into the piping system for the unfiltered beer;
the fluid that cannot be displaced by the introduction of the gas at the beginning of the cleaning step is transported into a separate intermediate tank, and for subsequent production is introduced upstream of said filter into the piping system for the unfiltered beer;
said at least one filter element is flushed directly into the gas-filled filter module, whereby a suspension of beer and diatomaceous earth is displaced into said filter and is conducted for a period of time in circulation through said filter, and the gas is at least partly displaced from said filter; and
the liquid volume from the intermediate tank is introduced at least partly into the suspension during a subsequent first runnings step during the flushing by means of a pump.

6. A method of operating a container filling plant being configured to fill containers, said container filling plant comprising: a filling machine being configured to fill empty containers with filtered liquid; a conveyor arrangement being configured and disposed to move empty containers to said filling machine; and a filtering arrangement being configured to filter liquid, said filtering arrangement comprising: a filter; a source of compressed gas being configured and disposed to supply gas to said filter; a storage tank being configured and disposed to store unfiltered liquid removed from said filter; a source of cleaning liquid being configured and disposed to supply cleaning liquid to said filter to clean said filter; a source of fresh filter material being configured and disposed to supply fresh filter material to said filter; said method comprising the steps of:
filtering unfiltered liquid in said filtering arrangement;
stopping the flow of unfiltered liquid through said filtering arrangement and stopping filtering of unfiltered liquid upon filtered build-up in said filter exceeding a predetermined level;
introducing gas into said filter and removing remaining unfiltered liquid from said filter to clean said filter;
storing said removed unfiltered liquid in said storage tank;
flowing cleaning liquid, from said source of cleaning liquid, through said filter and removing filtered build-up and filter material from said filter;
introducing gas into said filter and removing remaining cleaning liquid from said filter;
disposing fresh filter material in said filter, from said source of fresh filter material, and thus recharging said filter;
flowing said stored removed unfiltered liquid through said filter and filtering said removed unfiltered liquid in said filter;
flowing unfiltered liquid from said source of unfiltered liquid through said filter and filtering said unfiltered liquid with said filter; and
filling empty containers with filtered liquid in said filling machine.

7. The method of operating a container filling plant according to claim 6, wherein said steps of introducing gas into said filter further comprise introducing at least one of: carbon dioxide, nitrogen, and compressed air into said filter.

8. The method of operating a container filling plant according to claim 7, wherein said filter is filled at a pressure of one of (A) and (B):
(A) one bar to a maximum 8 bar; and
(B) one and one-half bar to two bar.

9. The method of operating a container filling plant according to claim 8, wherein:
said filter comprises a filter candle; and
said filter arrangement comprises at least one filter candle.

10. The method of operating a container filling plant according to claim 9, wherein:
the gas-filled filter is filled with filtered liquid, and then said at least one filter candle is flushed, whereby a suspension of liquid and/or cleaning liquid and filter material is introduced into said filter and is conducted for a period of time in circulation through said filter;
the liquid displaced by the introduction of the suspension is transported into an unfiltered liquid buffer tank;
the liquid displaced by the introduction of the suspension is transported into a separate intermediate tank and when production resumes is introduced upstream of said filter into the piping system for the unfiltered liquid;
the fluid that cannot be displaced by the introduction of the gas at the beginning of the cleaning step is transported into a separate intermediate tank, and for subsequent production is introduced upstream of said filter into the piping system for the unfiltered liquid;
said at least one filter element is flushed directly into the gas-filled filter module, whereby a suspension of liquid and filter material is displaced into said filter and is conducted for a period of time in circulation through said filter, and the gas is at least partly displaced from said filter; and
the liquid volume from the intermediate tank is introduced at least partly into the suspension during a subsequent first runnings step during the flushing by means of a pump.

11. A method of operating a filtered liquid providing plant being configured to filter an unfiltered liquid, said filtered liquid providing plant comprising: a filtered liquid handling arrangement being configured to handle liquid; and a filtering arrangement being configured to filter liquid, said filtering arrangement comprising: a filter; a source of compressed gas being configured and disposed to supply gas to said filter; a storage tank being configured and disposed to store unfiltered liquid removed from said filter; a source of cleaning liquid being configured and disposed to supply cleaning liquid to said filter to clean said filter; said method comprising the steps of:
filtering unfiltered liquid in said filtering arrangement;
stopping the flow of unfiltered liquid through said filtering arrangement and stopping filtering of unfiltered liquid upon filtered build-up in said filter exceeding a predetermined level;
introducing gas into said filter and removing remaining unfiltered liquid from said filter to clean said filter;
storing said removed unfiltered liquid in said storage tank;
flowing cleaning liquid, from said source of cleaning liquid, through said filter and removing filtered build-up from said filter;
introducing gas into said filter and removing remaining cleaning liquid from said filter;
flowing said stored removed unfiltered liquid through said filter and filtering said removed unfiltered liquid in said filter;
flowing unfiltered liquid from said source of unfiltered liquid through said filter and filtering said unfiltered liquid with said filter; and
providing filtered liquid.

12. The method of operating a filtered liquid providing plant according to claim 11, wherein said steps of introducing gas into said filter further comprise introducing at least one of: carbon dioxide, nitrogen, and compressed air into said filter.

13. The method of operating a filtered liquid providing plant according to claim 12, wherein said filter is filled at a pressure of one of (A) and (B):
(A) one bar to a maximum 8 bar; and
(B) one and one-half bar to two bar.

14. The method of operating a filtered liquid providing plant according to claim 13, wherein:
said filter comprises a filter candle; and
said filter arrangement comprises at least one filter candle.

15. The method of operating a filtered liquid providing plant according to claim 14, wherein the gas-filled filter is filled with filtered liquid, and then said at least one filter candle is flushed, whereby a suspension of liquid and/or cleaning liquid and filter medium is introduced into said filter and is conducted for a period of time in circulation through said filter.

16. The method of operating a filtered liquid providing plant according to claim 15, wherein the liquid displaced by the introduction of the suspension is transported into an unfiltered liquid buffer tank.

17. The method of operating a filtered liquid providing plant according to claim 16, wherein the liquid displaced by the introduction of the suspension is transported into a separate intermediate tank and when production resumes is introduced upstream of said filter into the piping system for the unfiltered liquid.

18. The method of operating a filtered liquid providing plant according to claim 17, wherein the fluid that cannot be displaced by the introduction of the gas at the beginning of the cleaning step is transported into a separate intermediate tank, and for subsequent production is introduced upstream of said filter into the piping system for the unfiltered liquid.

19. The method of operating a filtered liquid providing plant according to claim 18, wherein said at least one filter element is flushed directly into the gas-filled filter module, whereby a suspension of liquid and filter medium is displaced into said filter and is conducted for a period of time in circulation through said filter, and the gas is at least partly displaced from said filter.

20. The method of operating a filtered liquid providing plant according to claim 19, wherein:
the liquid volume from the intermediate tank is introduced at least partly into the suspension during a subsequent first runnings step during the flushing by means of a pump;
said unfiltered liquid comprises unfiltered beer;
said filtered liquid comprises filtered beer; and
said step of providing filtered liquid further comprises one of (C) and (D):
(C) filling beverage bottles with said filtered beer; and
(D) filling cans with said filtered beer.
